(19) United States
(12) Patent Application Publication
(10) Pub. No.: US 2017/0185169 A1
(43) Pub. Date: Jun. 29, 2017

(54) INTERACTIVE TILE SYSTEM, TILE CONNECTORS, AND RELATED METHODS

(71) Applicant: SHAFTESBURY TECH INC., TORONTO (CA)

(72) Inventors: Ted BIGGS, TORONTO (CA); Justin CAGUIAT, TORONTO (CA); Mike DOUCET, TORONTO (CA); Navdeep HAYER, AJAX (CA); Behzad JAZIZADEH, TORONTO (CA); Ryan LUSSING, TORONTO (CA); Sherlock SUNG, RICHMOND HILL (CA)

(21) Appl. No.: 15/378,594

(22) Filed: Dec. 14, 2016

Related U.S. Application Data
(60) Provisional application No. 62/267,271, filed on Dec. 14, 2015.

(51) Int. Cl. G06F 3/0346

(52) U.S. Cl. CPC G06F 3/0346

(57) ABSTRACT

A tile for use in a modular interactive media system includes a microprocessor, a sensor, a data communications subsystem in operative communication with the microprocessor and the sensor, and a casing. The casing has at least two faces, at least one face defining a user contact surface, and sides between the faces, at least one side cooperating with at least one side of a second tile and having an interconnecting portion with a first pair of alignment and data connection structures and a second pair of alignment and data connection structures complementary to the first pair. The first structures include a projection extending from the one casing side and a complementary recess. A first data connector is disposed in the projection and a second data connector is disposed in the recess. The second structures are rotated relative to the first structures.

### BACKGROUND

1. Technical Field

The present disclosure relates generally to interactive media systems, and more particularly to interactive media systems utilizing modular tiles as user interface devices.

2. Description of the Related Art

Electronic devices embodying toys or games generally include one or more user interfaces to permit users to control operation of the device. With the increasing popularity of tablets, smartphones, and mobile computers, these user interfaces are often restricted to the touchscreen, keyboard, or pointer interface integrated into the device; user input received by these user input mechanisms are converted to instructions that control the response of the device, which is displayed on the device's screen. More complex electronic devices or gaming systems that are not mobile may use external physical controllers such as joysticks and steering wheels to receive user input; responses to user input are then displayed on a separate display screen. Such toys and systems may emphasize sedentariness on the part of the user, since the user is generally expected to remain seated, or at least in a single position in order to interact with the device or system.

Still other gaming systems can encourage physical activity through the use of three-dimensional gestural or motion input, but require the user to either hold or wear a sensor capable of detecting gravity- or motion-induced forces, or alternatively require the user to be positioned in a defined region within the field of view of a camera or other detector in order to accurately detect movement. The assembly of the physical components of such systems may be too complicated for younger users.

### BRIEF DESCRIPTION OF THE DRAWINGS

In drawings which illustrate by way of example only embodiments of the present disclosure, in which like reference numerals describe similar terms throughout the various figures,

FIG. 1 is a schematic illustrating components of a tile-based modular interactive media environment.

FIG. 2 is a block diagram of select components of an example tile in the modular interactive media environment illustrated in FIG. 1.

FIGS. 3A, 3B, and 3C are plan view schematics illustrating possible layouts of select components within the example tile of FIG. 2.

FIG. 4 is a perspective view of a first example of a case assembly for the example tile of FIG. 2.

FIG. 5A is a perspective view of a second example of a case assembly for the tile of FIG. 2.

FIG. 5B is a cutaway view of the case assembly of FIG. 5A.

FIG. 6A is a front perspective view of a sidewall of the case assembly of FIG. 5A.

FIG. 6B is a rear perspective view of select components of the sidewall of FIG. 6A.

FIG. 7 is a block diagram of select components of an example base station for use in the modular interactive media system of FIG. 1.

FIG. 8 is a block diagram of select components of an example data processing system for use in the modular interactive media system of FIG. 1.

FIG. 9 is a flowchart illustrating an overview method for operating the modular interactive media system.

FIG. 10 is an interaction diagram depicting example data flow between multiple tiles and the base station of FIG. 1 during an initiation procedure.

FIG. 11 is an interaction diagram depicting example data flow between multiple tiles, the base station, and the data processing system of FIG. 1 during gameplay or another interactive activity.

FIGS. 12A to 12D illustrate example graphical user interfaces of the data processing system in response to detected tile state changes during an interactive activity.

FIGS. 13A to 13D are schematic diagrams illustrating alternative action assignments in dependence on a tile arrangement.

FIGS. 14A and 14B illustrate example graphical user interfaces of the data processing system in response to other detected tile state changes during an interactive activity.

### DETAILED DESCRIPTION

As mentioned above, electronic gaming platforms can use a range of user input mechanisms ranging from the integrated touchscreen, keyboard, etc. of a tablet, smartphone, or personal computer, to peripherals such as joysticks, steering wheels, to motion detection and capture equipment. Each of these forms of user input has inherent advantages and disadvantages; of note, however, is that the majority of gaming user interfaces generally do not, in and of themselves, promote physical activity on the part of the user: integrated user input mechanisms such as tablet touchscreens and peripherals such as joysticks generally require the user to be substantially sedentary in order to make effective use of the interface.

Motion detection equipment necessarily requires the user to move; however, the user's motivation to actually move is supplied by the accompanying software, and not by the motion detection equipment itself. Motion detection systems can detect smaller gestures, and thus do not absolutely necessitate significant physical movement or displacement on the part of the user in order to function. It is the accompanying game software that must direct the user to engage in movement in order to achieve the objects of the game.

Accordingly, the embodiments and examples described herein provide a modular interactive media system that utilizes a set of one or more tiles interconnected in one or more configurations. The tiles provide a reconfigurable user input mechanism that, in the examples discussed below, receives pedal input (i.e., the user steps on the tiles to apply force). The tiles communicate with a data processing system that provides feedback to the user's input, generally in the form of audiovisual responses (e.g., in the context of a game). In order to facilitate use of the system, a novel combination physical connector and data connector mechanism is provided to facilitate alignment and interconnection of the tiles.

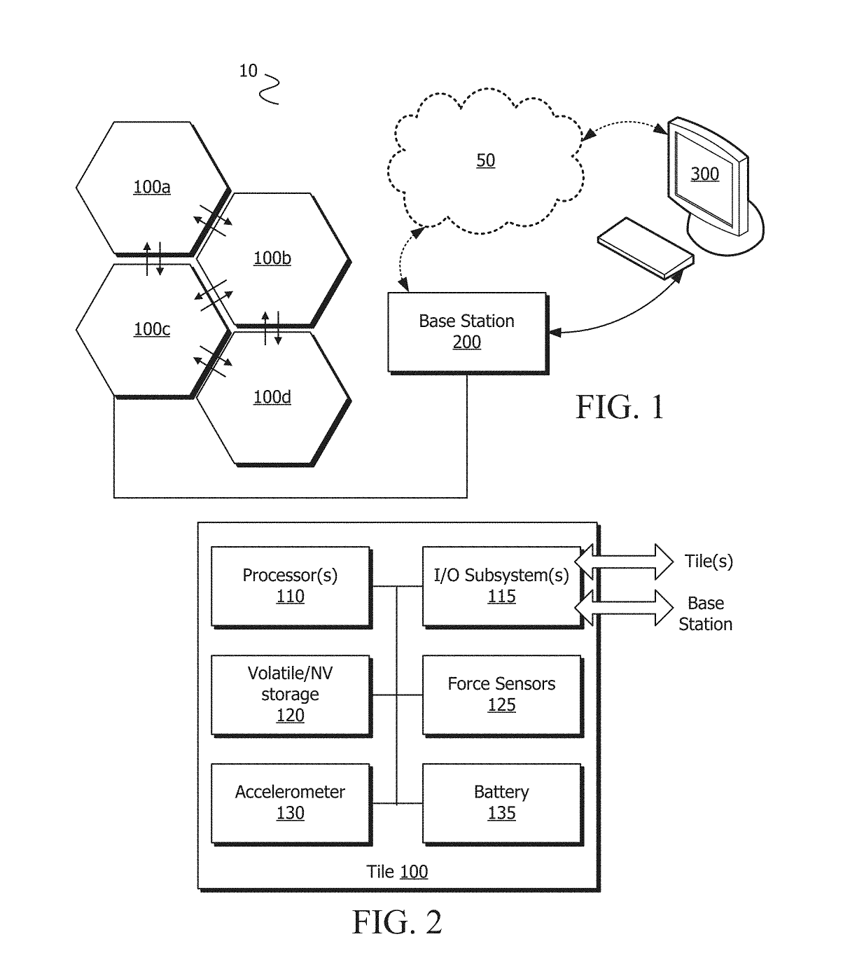

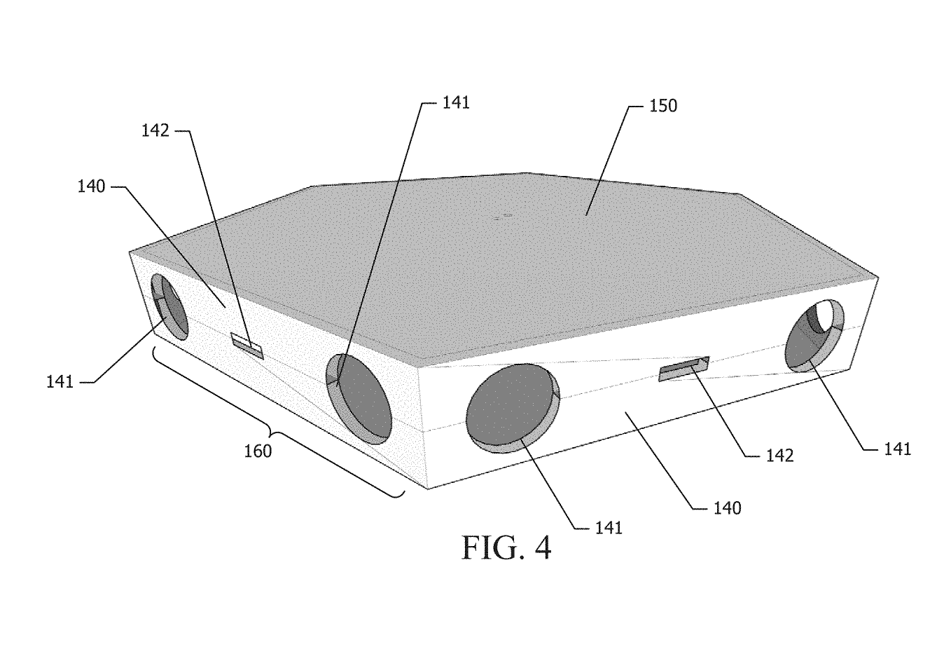

FIG. 1 provides an overview of an example interactive media environment 10 utilizing a set of modular interface devices arranged in a tiled configuration. A set of one or more tiles 100, here indicated as 100a-d, is arranged in interlocking arrangement, as illustrated. For ease of exposition in the accompanying drawings, the tiles 100 are illustrated as being spaced apart to better illustrate their respective perimeters, and the interlocking arrangement between the tiles is not illustrated in the schematic illustrations but is described in further detail with reference to FIGS. 4-6.

Generally, the tiles have a geometry that permits their arrangement edge-to-edge so as to form a substantially continuous surface. In the illustrated examples, which should not be considered to be limiting, the tiles 100a-d are all hexagonal in shape with the same dimensions. For ease of use and manufacture, all tiles have a relatively simple polygonal shape suitable for monohedral tiling. Thus, for example, the tiles may have a square, rectangular, hexagonal, equilateral rhomboid, or equilateral triangular shape, which may be used with either face of the tile facing up. However, more complex shapes are may be used provided they are adapted for tiling. For instance, a more complex polygonal shape modified to include further projections and recesses in its perimeter, or to include cooperating contoured edges (e.g., sinusoidal edges) may still admit tiling and thus the formation of a substantially continuous surface. In still other implementations, a plurality of different tile shapes and/or sizes combinable to form a substantially continuous surface can be provided (e.g., a combination of hexagonal and pentagonal tiles, or a combination of rectangles or squares of different sizes).

Each tile includes an input device, such as a force sensor (not illustrated in FIG. 1), and communications subsystems to permit bidirectional inter-tile communication of data, as indicated by the pairs of arrows between tiles in FIG. 1. At least one tile, tile 100c in FIG. 1, is in fixed or wireless communication with a base station 200 and provides data pertaining to that tile and optionally other tiles to the base station 200. In alternate implementations, each tile 100a-d may be provided with a wireless transmitter so as to permit each tile, regardless of location within the interlocking arrangement, to communicate directly with the base station 200 rather than via a path through the communications subsystems of neighbouring tiles.

The base station 200 in turn communicates tile data to a data processing system 300, either directly via a direct fixed or wireless connection, or through a network 50. The network 50 in this illustration is representative of any network configuration and need not be limited to a local area network or personal area network; in some implementations, for example, communication between the base station 200 and the data processing system 300 may be through a public or private wide area network, such as the Internet.

The data processing system 300 processes the tile data for input to an interactive program executing on the data processing system 300, and renders responses for presentation to the user. The data processing system 300, as discussed below, may be a personal computer system, tablet, or similar device. However, it will be appreciated by those skilled in the art from the ensuing description that the function of the base station 200 and the data processing system 300 may be integrated in a single device in the environment 10; for instance, the data processing system 300 may be a personal computer system configured to receive the tile data from the tile 100c and process the tile data as input for the interactive program. In a further alternative, however, at least some functions may be implemented by the tile 100c; the tile 100c may be configured to receive data from each other tile, and process the tile data as input and communicate this input to the data processing system 300. In that case, each tile 100 in the set may be similarly configured due to the modular nature of the environment 100, so that any tile can operate as a base or master tile should the specific tile 100c not be included in a particular interlocking arrangement.

It will further be understood by those skilled in the art that while sets of tiles 100 have been depicted in certain numbers and arrangements, the arrangement of the tiles and the numbers of tiles in a given interlocking arrangement need not be limited to the specific examples illustrated herein. As will be discussed below, a set of tiles may include one, two, or three tiles, or more than four, and may be arranged to define irregularly-shaped but substantially continuous surfaces. Tile size can be approximately 30 cm to 35 cm across, or a suitable size that accommodates the anticipated user contact. For instance, where it is expected that the user will step on the tiles, a size ranging from 30 cm to 35 cm may be sufficient to accommodate most adult feet; but if use of the tiles is expected to be limited to use by children or manual operation (i.e., through contact or force applied by the user's hand), a smaller size up to around 25 cm may be sufficient.

FIG. 2 illustrates select components of each tile 100. Operation of the tile is generally controlled by a main microprocessor or processors 110 executing stored code and in operative communication with other components of the tile 100. One or more input/output subsystems 115 are included for communication with other tiles and the base station 200. These subsystems 115 may include a radio transceiver or transmitter for use in wireless communications, if wireless communication is implemented. However, communication between adjacent tiles, and between the tiles and the base station 200, can alternatively be effected by direct contact connections implementing either serial or parallel interfaces.

Each tile 100 also includes volatile and/or non-volatile memory 120 for storing executable code and tile data either for itself or for other tiles. A discrete memory component may not be provided; instead, this memory may be implemented in the microprocessor(s) 110 or in a system-on-chip (not illustrated) including the microprocessor(s) 110 and an I/O subsystem 115, and/or other functional components of the tile 100. An identifier (ID) for the tile is stored in non-volatile memory.

The tile 100 includes at least one sensor to detect user input in the form of contact or pressure, and/or tile orientation (i.e., face-up or face-down). In this example, at least one force sensor 125 is included. The force sensor can be a force-sensitive resistor (FSR) of sufficient accuracy to detect a certain level of force applied to a face of the tile 100, although other types of force sensors, such as strain gauges, capacitive, piezoelectric or piezoresistive devices, or pressure sensors may be used in place of a FSR if suitable for the tile construction. A further sensor, such as a 2-axis or triaxial accelerometer 130, can also be included in the tile 100 to detect the tile's “flip” state or vertical orientation (i.e., which face of the tile is facing up), or changes to the tile's vertical orientation while it is being flipped from one face to the other.

Power for the various functional components of the tile may be provided either by a removable or non-removable, rechargeable or non-rechargeable battery source 135, but to reduce the need for maintenance of individual tiles, the power supply for the tiles 100 can be provided by the base station 200 or from another adapter connected to mains power. Thus, in place of the battery 135 indicated in FIG. 2, an additional power port and/or connector may be included in the tile 100. In the case of a tile 100 not directly connected to the base station 200 or the other adapter, the tile 100 would necessarily draw power from an adjacent tile 100, which in turn would draw power from a further adjacent tile or the base station 200. In one implementation, a power connection is integrated into the combination alignment/data connection assembly provided on each tile, as discussed below.

It will be understood by those skilled in the art that the components illustrated in the various accompanying drawings (in particular FIGS. 1-8) are merely representative of particular aspects of the various elements of the environment 10 (i.e., tile 100, base station 200, and data processing system 300), and that other components that the person skilled in the art would appreciate may or should be included in such systems have been excluded from the drawings and this description only for succinctness. Furthermore, those skilled in the art will understand that the environment 10 may be successfully used with the various examples described herein even when some components described in relation to the tile 100, base station 200, and/or data processing system 300 are omitted.

As mentioned above, the tile 100 may have at least one sensor. In the examples discussed below, a primary use of the tiles 100 is to provide a substantially continuous floor area on which a user can stand and apply pressure to one or more tiles 100. Thus, at least one force sensor is preferably affixed to or in contact with the underside of at least one face of the tile for the purpose of detecting force applied to that face; in dependence on the structure of the tile, where the tile is capable of being used in a flipped state a further force sensor is affixed to or in contact with the underside of the opposing face of the tile to detect force applied to the opposing face. The disposition of sensors within a tile 100 may depend on the tile geometry and the need to detect either varying levels of force applied to the tile, differences in force applied across a single tile, or both.

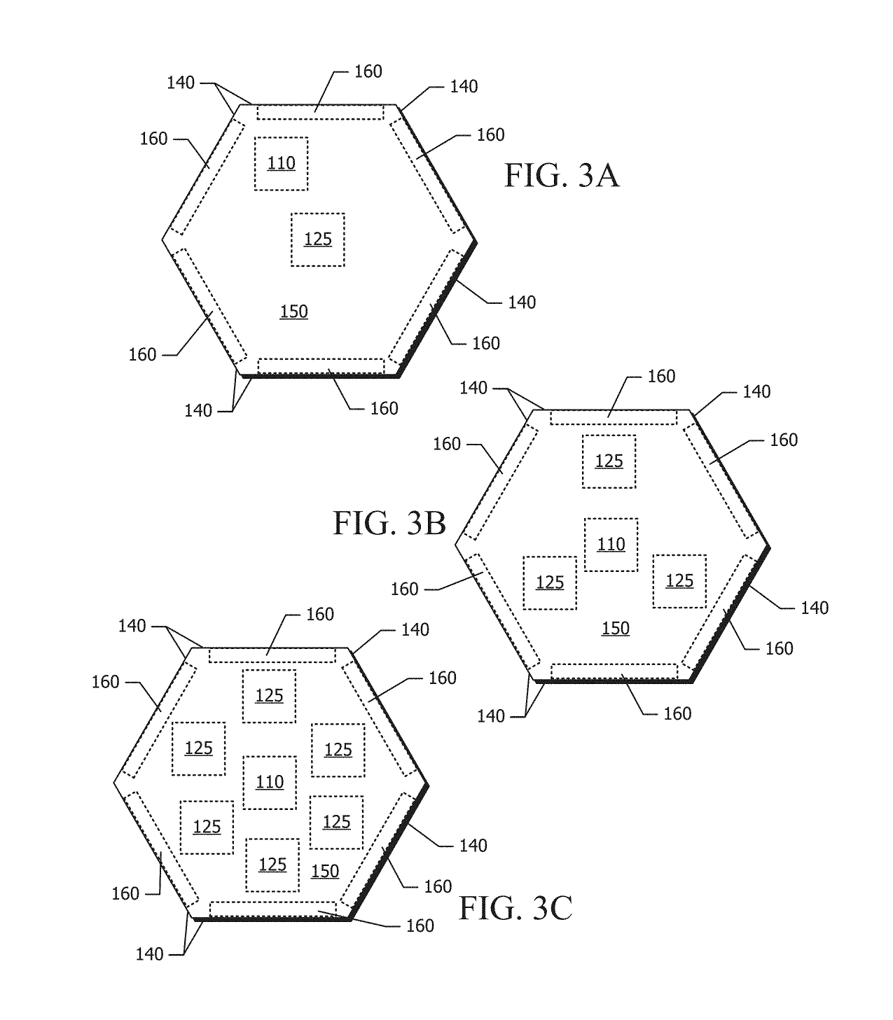

FIGS. 3A-C illustrate possible locations of the sensors within a tile 100. In the simple example of FIG. 3A, a single force sensor 125 is provided for each operational face 150 of the tile 100, i.e. each face intended for detecting or receiving user input through the application of force. Thus, the force sensor 125 may be substantially centrally located under the operational face 150 of the tile 100. Other components, such as the processor(s) 110 or accelerometer 130 (not shown) may be located elsewhere within the tile. Each sidewall 140 of the tile adapted for connection or contact with an adjacent tile 100 or base station 200 is further provided with a connection structure 160, discussed in further detail below.

In a more detailed implementation as in FIG. 3B, more than one force sensor 125 is positioned under each operational face 150 of the tile in order to improve the detection threshold for the tile as a whole; in the example of FIG. 3A, force applied near an edge of the tile 100 may be not be detected by the force sensor 125, or the force detected by the more centrally-located force sensor 125 may not meet a required threshold level to register as a user action. Thus, in FIGS. 3B and 3C, multiple force sensors 125 are distributed under each operational face 150 to better detect forces applied at non-central locations on the tile 100. In the case of FIG. 3B, force sensors 125 are distributed at points between the geometric centre and select sidewall 140 of the tile 100; in the example of FIG. 3C, the force sensors 125 are positioned between each sidewall 140 and the geometric centre of the tile 100.

In the case of multiple force sensors 125 on a single face, the processor(s) 110 may be configured to process all force sensor readings in the aggregate or independently. For example, the processor(s) 110 may sample every force sensor 125 in the tile 100 on a periodic basis, and compute the mean value of each force sensor reading for comparison against a threshold value; when the average reading meets or exceeds the threshold value, the applied force or pressure state of the tile is determined to be “on” or “active”; when the average reading is below the threshold, this state is determined to be “off” or “inactive”. Alternatively, each individual force sensor 125 may be sampled individually and their individual values compared by the processor(s) 110 to determine the quality or characteristics of a detected applied force; for example, a differential in force sensor readings of two force sensors 125 exceeding a second threshold may result in a determination that the applied force is off-centre or insufficiently precise to change the force or pressure state of the tile from “off” to “on”.

As noted above, the examples depicted in the accompanying drawings consist of hexagonal tiles. The foregoing arrangements may, of course, be adapted to other tile shapes. Further, while square force sensors 125 are depicted, the force sensors 125 may have any suitable configuration.

It will be appreciated by those skilled in the art that since each tile 100 includes components such as a processor 110, accelerometer 130, force sensors 125, I/O subsystems 115, etc. the construction of the tile 100 preferably protects these components from damage as the tiles 100 are used. Generally as illustrated in FIG. 4, each the casing of each tile 100 includes a pair of opposing faces 150 (only an upper face 150 is shown in FIG. 4) and a plurality of sidewalls 140 extending between the opposing faces 150. The faces 150 and sidewalls 140 thus define an interior cavity for retaining the various functional components discussed with reference to FIGS. 2 and 3 above. Suitable materials for the casing components include polycarbonates and other thermoplastic polymers of sufficient strength to withstand appropriate forces applied in the normal course of use and to transmit sufficient applied force to the force sensors 125 disposed within the casing.

To permit the construction of a substantially continuous surface from a plurality of tiles 100, the sidewalls 140 of the casing include physical connectors that allow tiles to be aligned and removably joined or fastened to one another. In addition, where data communications (and optionally power transmission) are effected by fixed connections between adjacent tiles 100, provision for physical data and/or power connectors are also included in each sidewall 140, as indicated in FIG. 4 by the elements of the connection structure 160. In this particular example, slots 142 can accommodate data and/or power connectors (not shown) while apertures 141 accommodate physical connectors. These physical connectors can include physical attachment mechanisms such as hook and loop fasteners, reusable adhesives, and magnets.

However, as mentioned above, the tiles 100 may be useable with either face 150 operational for detecting applied forces; thus, to maximize the reconfigurability of the tiles into different arrangements, the physical connectors must be configured so as to permit two adjacent tiles 100 to be removably joined whether both of them are “face-up” (i.e., have the same face 150 facing up) or one is “face-up” and the other “face-down”. At the same time, physical connections required for transmitting data and/or power must also operate even when two adjacent tiles 100 have opposite faces facing up. Accordingly, in one embodiment, combination alignment and data connection structures are provided on each sidewall 140 configured for interconnection with a sidewall 140 of a neighboring tile 100.

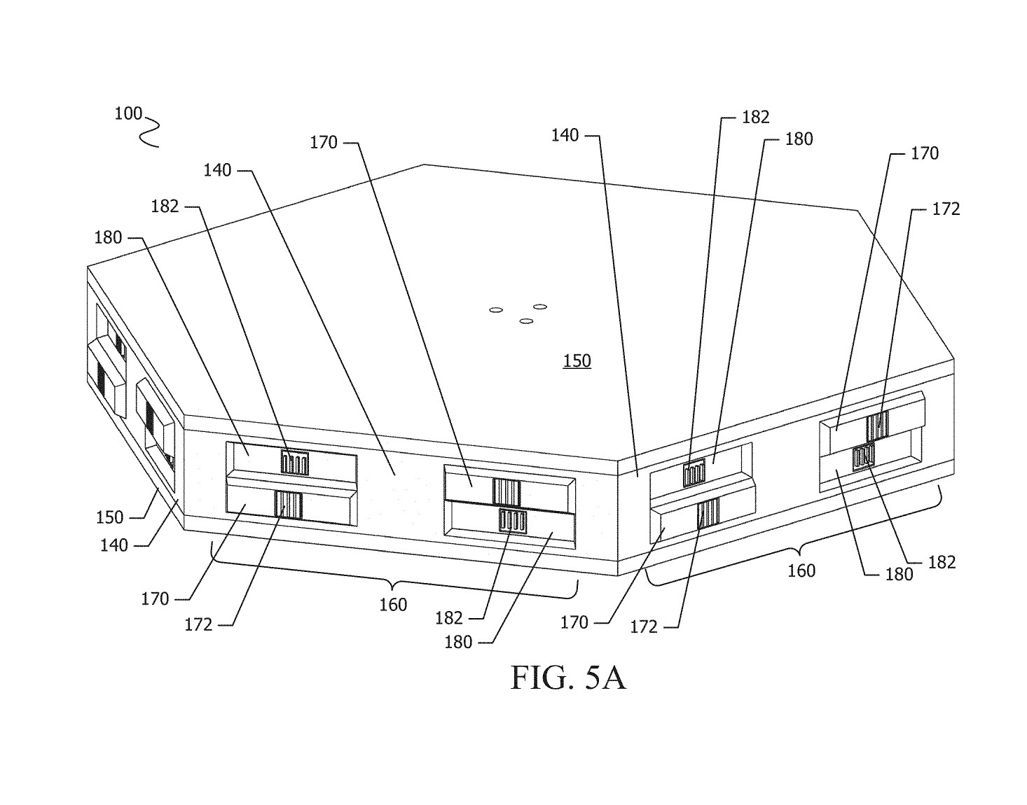

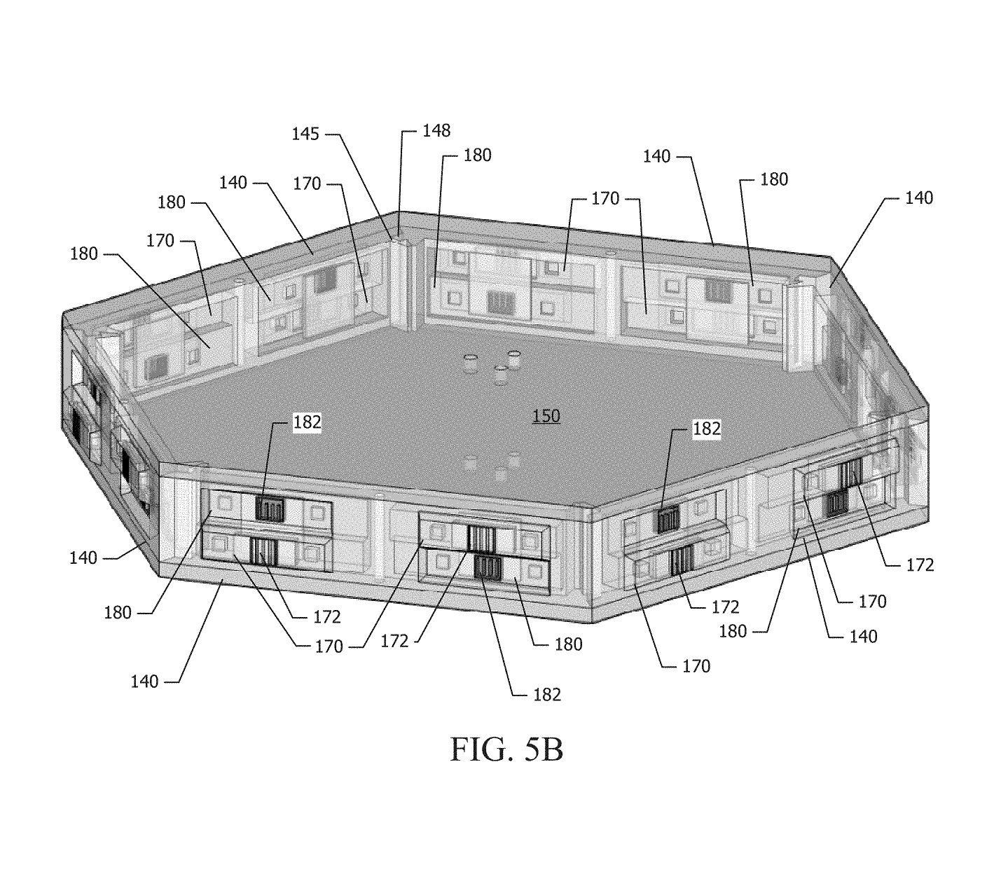

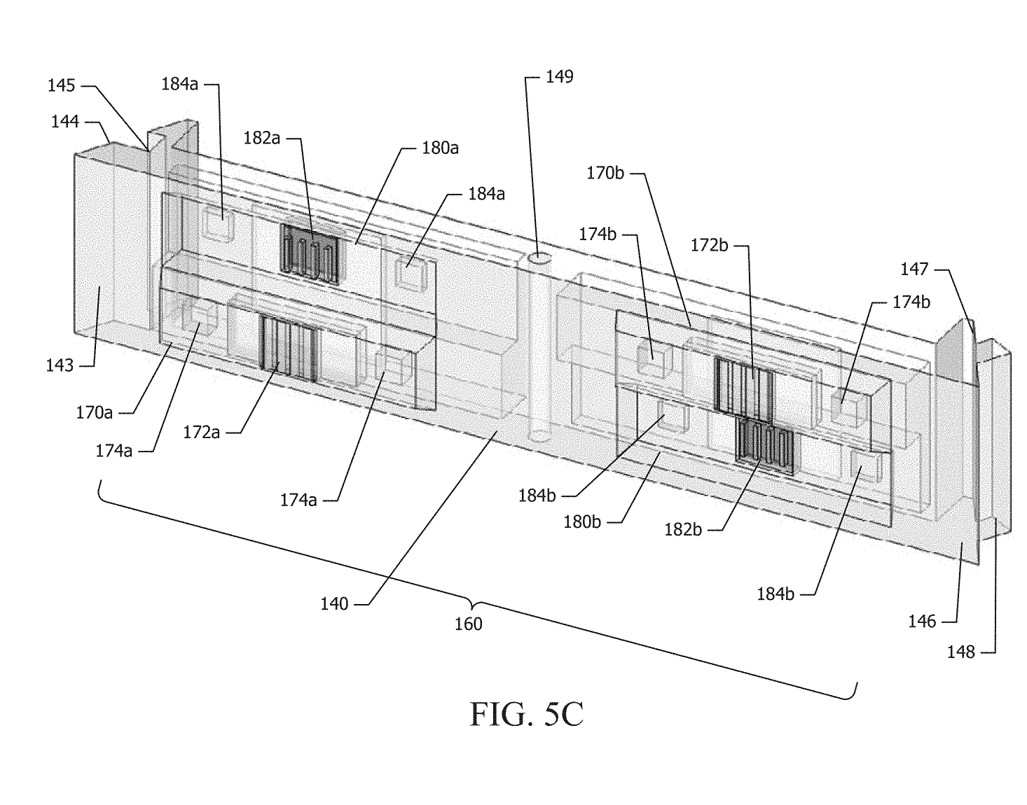

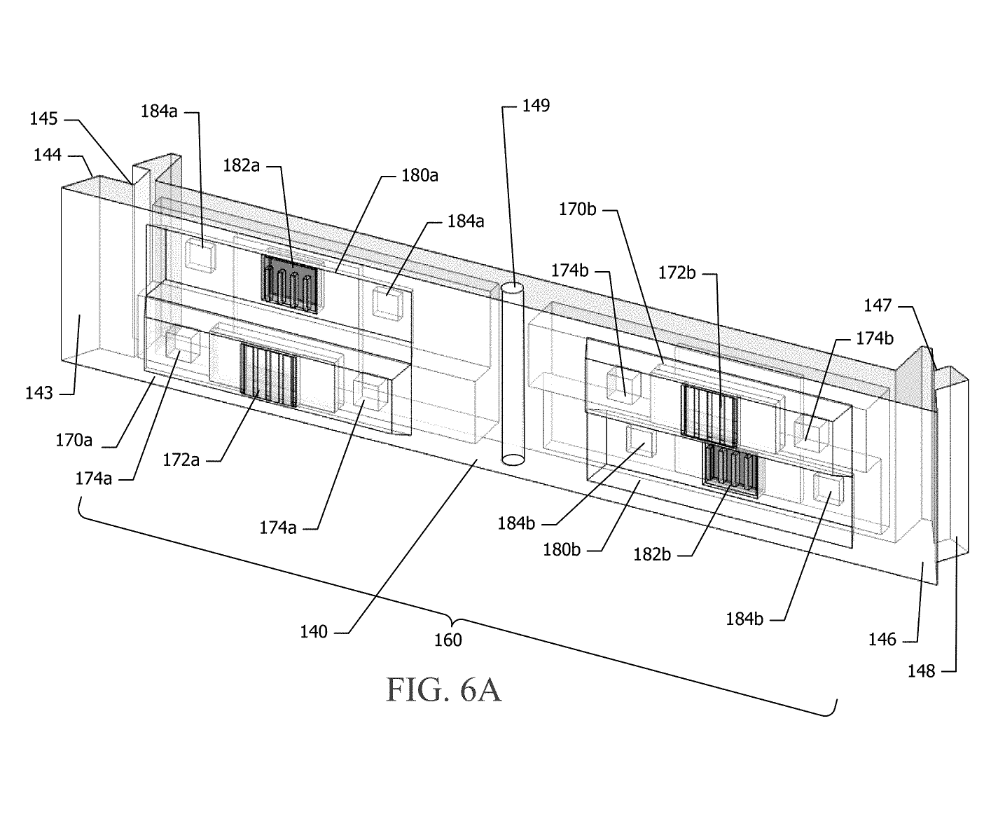

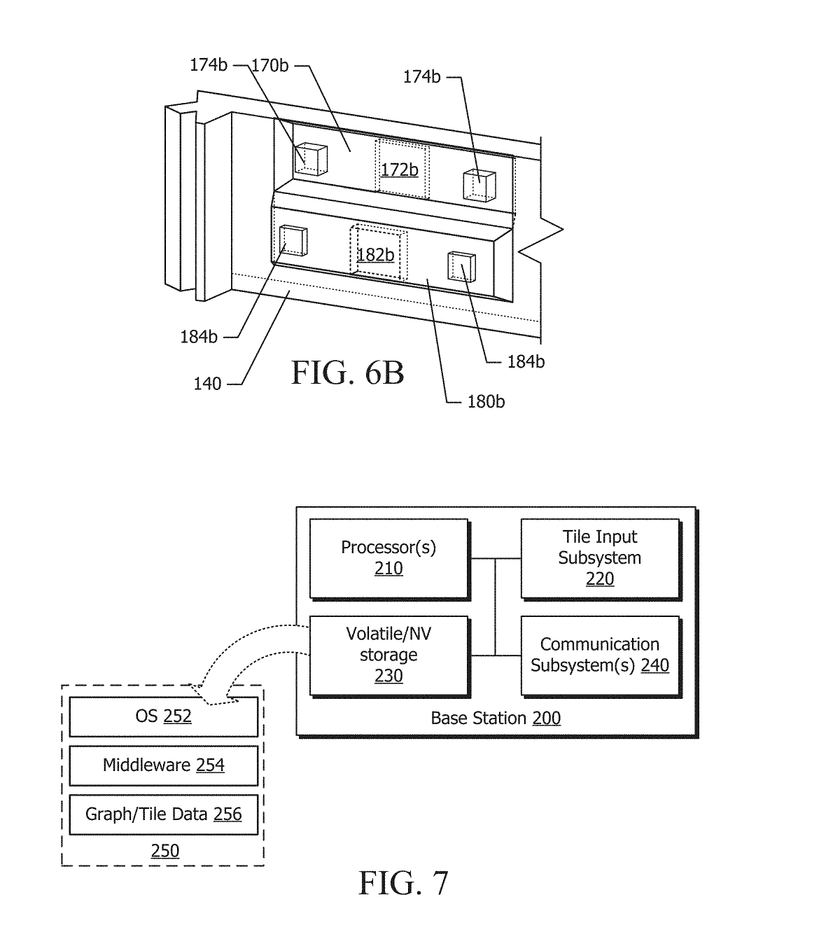

An example of such an embodiment is illustrated in FIGS. 5A to 6B. FIG. 5A illustrates an assembled tile casing or case assembly having a connection structure 160 on each sidewall 140, such that any sidewall 140 of the tile 100 can be connected to a sidewall 140 of another such tile 100. Each connection structure includes a plurality of complementary projections 170, which extend from a surface of the sidewall 140, and recesses or cavities 180, which are provided in the sidewall 140. Each projection 170 includes a data (and optional power) connector 172; each recess includes a corresponding data (and optional power) connector 182. As discussed in further detail below, the shape and arrangement of the complementary projections 170 and recesses 180 enable alignment of the sidewall 140 with a sidewall 140 of another tile 100 having the same connection structure 160, and facilitate mating of the complementary data connectors 172, 182. In the example of FIG. 5A, each sidewall 140 includes the connection structure, and each sidewall 140 is connected to form the sides of the tile 100; the sidewalls 140 are attached to two opposing faces 150. FIG. 5B illustrates a cutaway view of the case assembly shown in FIG. 5A, without the upper face 150 in place. In this view, the lower face 150 is visible. In the example of FIG. 5B, the sidewalls 140 interlock with one another by complementary grooves 145 and tongues 148, which are formed in end faces of the sidewall 140.

Turning to FIG. 6A, the sidewall 140 and its combination alignment and data connection structure is shown in further detail. Each sidewall 140 of each tile 100 in the system 10 includes two such combination structures in order to accommodate changes in orientation between two adjacent tiles 100. Each combination structure includes a complementary projection-recess pair that not only provides for alignment of two adjacent tiles during assembly, but also contains complementary data (and optional power) connectors. As can be seen in the drawing, a first combination structure includes projection 170a and complementary recess 180a. The recess 180a is sized and shaped to receive a projection having the size and shape of projection 170a. Each of the recess 180a and projection 170a includes, substantially at its centre, a data connector 182a, 172a respectively. One of the data connectors 182a, 172a is male and the complementary connector 172a, 182a is accordingly female. In this example, the male connector 182a is provided in the recess 180a and the female connector 172a is provided on the projection 170a. In this particular example, the connectors are male and female surface mount terminal connectors.

A complementary combination alignment and data connection structure is provided adjacent the first combination structure. This complementary structure includes a projection 170b and female data connector 172b, and recess 180b and male data connector 182b, but rotated at 180° to the first combination structure, and the two pairs of combination alignment and data connection structures are preferably substantially centered on the sidewall 140 surface. It will thus be appreciated that when sidewalls 140 of two tiles 100 having the same combination alignment and data connection structures face each other with the tiles having the same vertical orientation (i.e., both “face-up”), the projection/recess 170b, 180b of the first tile can mate with the recess/projection 180a, 170a of the second tile, and the recess/projection 180a, 170a of the first tile can mate with the projection/recess 170b, 180b of the second tile, and each mating recess and projection will accordingly have a corresponding male and female data connector. Furthermore, when one of the tiles 100 is flipped with respect to the other such that its other face is face-up, the projection/recess 170b, 180b of the first tile will mate with the recess/projection 180b, 170b of the second tile, and the recess/projection 180a, 170a of the first tile can mate with the projection/recess 170a, 180a of the second tile; and again, each mating recess and projection will have a corresponding male and female data connector.

In this implementation, the fit between complementary recess 180a and projection 170a of two adjacent tiles 100 need not be an interference or friction fit; rather, the recess 180a and projection 170a cooperate with a corresponding projection and recess of another tile 100 simply to provide alignment guidance to the user in assembling a continuous surface of tiles 100 to ensure that the male and female data connectors 172a, 182a enter into contact with the corresponding female and male connectors of the other tile. To this end, the projection 170a can have a tapered profile, as illustrated in FIG. 6A with a substantially trapezoidal prism shape. The recess 180a is correspondingly tapered in the shape of a substantially trapezoidal trough. The complementary tapering profiles of the recess 180a and projection 170a assist the user in guiding the data connectors towards each other, even when the user initially places the sidewalls 140 of two tiles 100 without perfect alignment between the corresponding data connectors of each tile 100. Other tapering profiles, such as a half-cylindrical profile, may be used as well.

Since the fit between complementary projections and recesses is not a friction fit, the combination structures on the sidewall 140 can further include fasteners to detachably mount the sidewalls 140 of two adjacent tiles 100 in close enough proximity so as to ensure a functional connection between the surface mount connectors. In the example of FIG. 6A, pairs of complementary magnets (with opposing poles facing the exterior surface of the sidewall 140) are disposed on the interior of the sidewall 140 within each projection or recess as indicated by magnets 174a, 184a, 174b, and 184b. The position of magnets 174b, 184b may be more clearly seen in the rear perspective view of a portion of the sidewall 140 in FIG. 6B. The magnetic field of each magnet penetrates the sidewall 140 sufficiently to attract its complementary magnet in the other sidewall 140. Other physical connection means may also be used, such as the aforementioned hook and loop or reusable adhesive fasteners.

It will be appreciated by those skilled in the art that the projections and recesses without a tapering profile (e.g., a corresponding rectangular projection and rectangular recess) will also function; however, such profiles require the user to initially hold two tiles such that their adjacent sidewalls 140 are already substantially in alignment in order to mate the projections and recesses, which can be more challenging for young or less physically coordinated users and may result in damage to the sidewalls or data connectors when users attempt to force misaligned sidewalls into engagement. The tapered profiles of the projections 170a, 170b and recesses 180a, 180b provide both alignment guidance and tolerance for initial misalignment by the user. However, if rectangular or other profiles with a friction or snap fit are used, the need magnets 174a, etc. or other fasteners may be avoided. Further, if a data connector relying on a friction fit for contact, rather than a surface mount connector, is used—for instance, a data port and plug combination—the friction fit of the data connector components may substitute for the magnets or other fasteners as well.

If power connections between tiles 100 are required, the power connectors may be incorporated into the connectors 172a, 172b, 182a, 182b in the sidewalls 100 as well.

In this example, the sidewall 140 is included with complementary tongue-and-groove structures on either end 143, 146 of the sidewall 140. At a first end 143, an end face 144 is angled to face a corresponding end face 147 of a second end 146 of a second sidewall 140. The first end 143 includes a slot or groove 145 formed in the end face 144. At the other end 146, a corresponding tongue 148 is formed in the end face 147 and is sized to slide fit into the slot or groove 145 of a first end 143 of another sidewall 140. Thus, to assemble the casing, a number of sidewalls 140 are joined using the complementary tongue-and-groove ends, and each face 150 (not shown in FIG. 4) is attached to each sidewall 140 by means of screws or other fasteners received in the bore 149 of each sidewall 140.

Moving on to the base station 200, FIG. 7 is a block diagram illustrating select functional components of the base station 200. The base station 200 executes code stored in memory 230 of the base station using one or more microprocessor(s) 210. Code stored in the memory 230 can include an operating system 252, middleware 254, and tile data 256, which can include mapping or graph data defining the physical arrangement of the interlocking tiles 100 in communication with the base station 200. However, some or all components of the operating system 252 may be embedded as firmware in integrated memory of a main processor 210. The middleware 254 executing on the base station 200 receives tile data via a tile input subsystem 220, which may be a fixed serial or parallel data connection or alternatively a wireless communications subsystem, and determines not only the physical arrangement of the tiles based on connection information received from the tiles 100, but also the state of each tile 100 (e.g., pressure on or off, flip state). This tile data is converted to an appropriate input for an interactive system executing on the data processing system 300, and is transmitted by the base station 200 to the data processing system 300 using an appropriate communication subsystem 240. As mentioned above, the connection between the base station 200 and the data processing system 300 may be a direct or network connection; the communication subsystem 240 can be any design appropriate to the communications protocol in use.

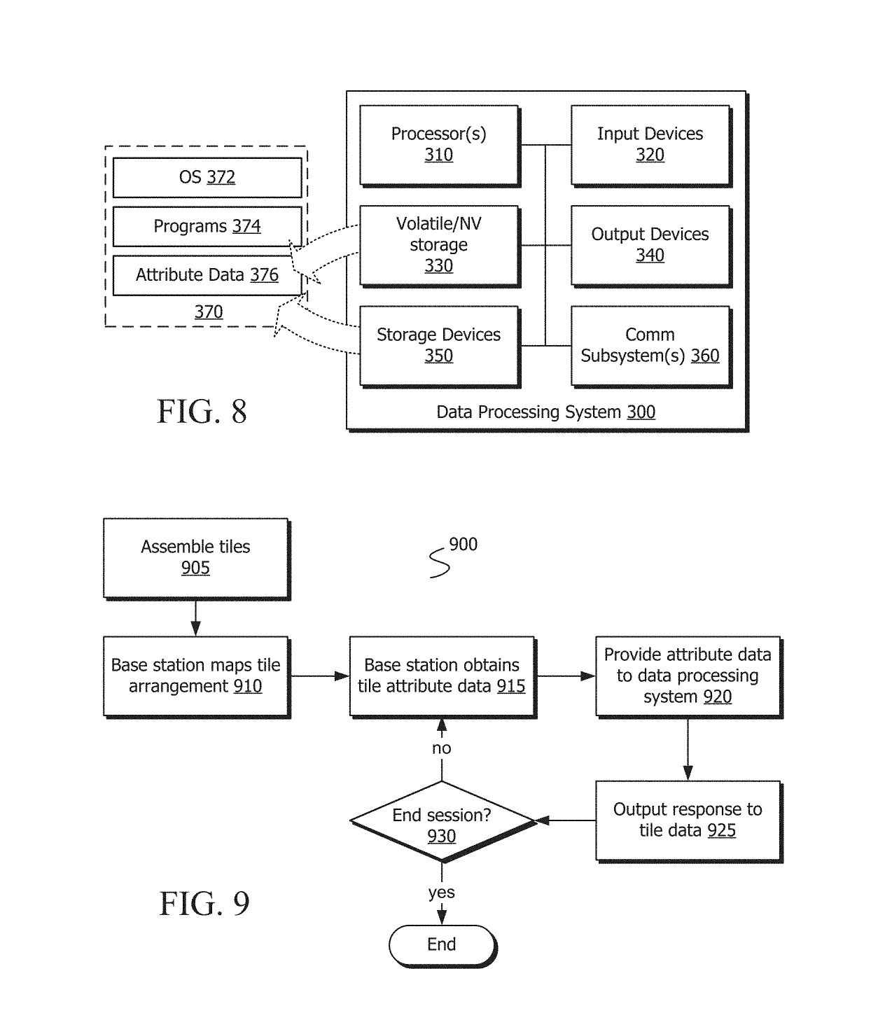

Functional components of an example data processing system 300 are illustrated in FIG. 8. The data processing system 300 may be embodied in a single device, such as a mobile computer (e.g., laptop computer, tablet computer, or smartphone), or in a system such as a desktop computer including a separate processing unit, user input device (e.g., mouse, keyboard), and display screen. While the example data processing system 300 in this description is conceived to be a desktop computer or tablet computer, it will be appreciated by those skilled in the art that other electronic media devices, such as televisions or other display systems, may be used in cooperation with the base station 200 instead.

Operation of the data processing system 300 is generally controlled by one or more main processors 310. The system may be operated under mains power or may be a battery-powered device; these features are not illustrated in FIG. 8 for ease of exposition. Data, programs, and other instructions or information can be stored in one of several possible memory components of the system 300, such as internal volatile or non-volatile storage 330 (which can be integrated with other components such as the processor 112 or provided as distinct components). Information can also be stored in the system 300 on other storage devices 350, such as hard drives, flash drives, and memory cards or on peripheral devices not illustrated in FIG. 8.

Typically, software and data components 370 such as the operating system 372, programs 374, application data are stored in persistent memory of the data processing system 300. The programs 374 in this example can include applications configured to use the tile data received from the base station 200 and/or tiles 100. Attribute data for the tiles 100 in the interactive media system 10 may likewise be stored in persistent storage such as a storage device 350, but will more likely be stored in a transient form in memory (e.g., random access memory) 330. In some systems, some components of the operating system 372 may be embedded as firmware in integrated memory of the processor 310.

The data processing system 300 may be provided with one or more user or sensor input devices 320. User input devices can include a touch and/or pointing device, such as a touchscreen, touchpad, mouse, or trackball; a keyboard; security peripherals such as a biometric scanner; and multimedia input devices, such as cameras or microphones. The system 300 may also have environmental or contextual input devices such as an orientation or inertial navigation sensor (particularly in the case of a touchscreen device), ambient light sensor, or a global positioning system (GPS) or other location detection module. The system 300 can also include one or more output devices 340, including in particular a display screen, which may be integrated in the chassis of the data processing system 300, or else provided as a peripheral device. The system 300 may be configured to output data to an external monitor or panel, tablet, television screen, projector, or virtual retinal display, via a data port or transmitter, such as a Bluetooth® transceiver, USB port, HDMI port, DVI port, and the like. The data port or transmitter may be one of the communication subsystems 360 illustrated in FIG. 8. Graphics data to be delivered to the display screen is either processed by the processor 310, or else by a dedicated graphics processing unit, not included in FIG. 8. Other output devices include speakers, and haptics modules. Not all of these suggested input or output devices are required, and many may be omitted. For instance, where the primary user interface of the system 300 is a touchscreen, a physical keyboard may be omitted altogether.

Communication functions, including data communication with the base station 200, are performed through one or more communication subsystems 360 in communication with the processor(s) 310. Other functional components used to accomplish communication functions, such as antennae, decoders, oscillators, digital signal processors, and the like, may be considered to be part of these subsystems. The particular design of a communication subsystem is dependent on the communication network 50 with which it is intended to operate. The communication subsystems 360 may include adaptors for use with wired connections as well.

FIG. 9 illustrates an overview method of operation 900 for the interactive media system 10. At an initial stage, a user interconnects connects one or more tiles 905 in any desired assembly. The actual configuration may be selected by the user according to the use to which the user wishes to put the tiles; on the other hand, as discussed below, the use to which the assembled tiles may be put may be determined by the actual interconnections between the tiles, and the number of tiles in the set. The tile assembly is also connected to the base station 200 (or data processing system 300, if no base station 200 is used), and power source, if necessary. Each tile is initialized, if necessary.

At 910, as part of an initialization process the base station 200 maps the arrangement of tiles. The tile arrangement may be represented by a graph structure in memory of the base station 200 or other component of the interactive media system 10 functioning as the base station 200 (referenced below simply as the “base station 200”), using an appropriate graph constructor algorithm.

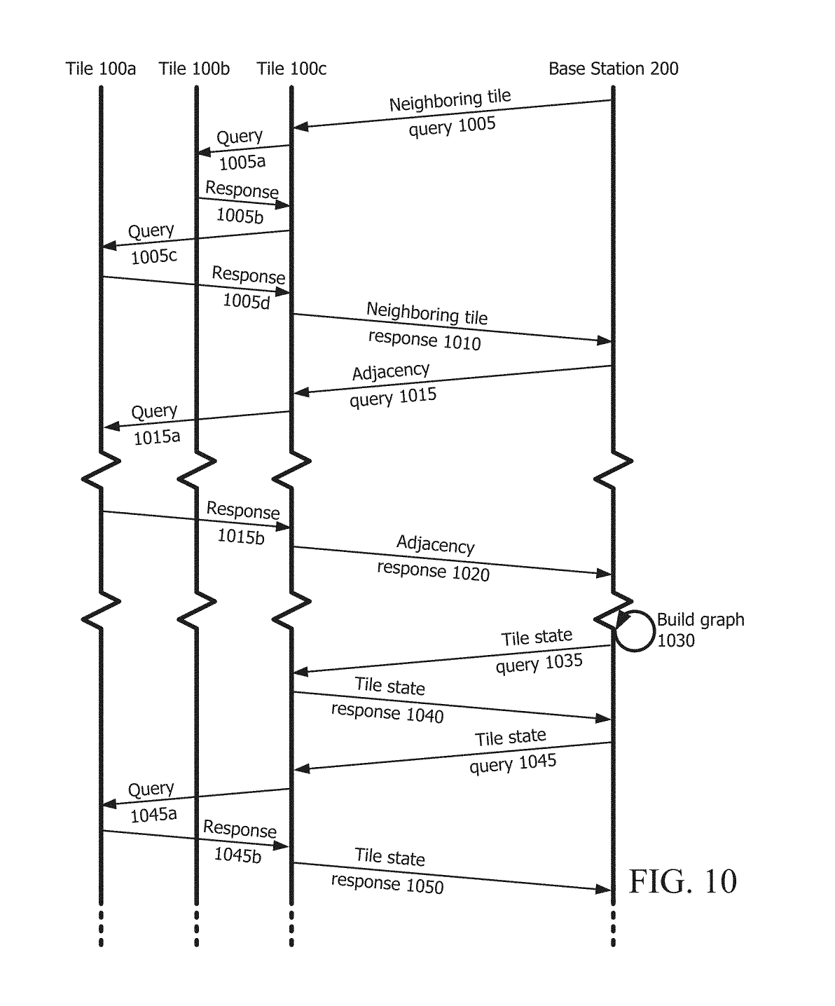

A possible sequence of communications between the base station 200 and the interconnected tiles 100 is illustrated in FIG. 10. In this example, the tile assembly is presumed to comprise tiles 100a, 100b, and 100c connected as illustrated in FIG. 1. Initially, a query 1005 is passed from the base station 200 to its immediately connected tile, i.e., tile 100c. This query 1005 requests information about the tiles neighboring tile 100c. Tile 100c in turn determines which of its data connectors is connected to a corresponding data connector of another tile, and queries each of its connected tiles (in this case, tiles 100b and 100a) in further queries 1005a, 100c for the tile IDs of those tiles. Once responses 1005b, 1005d are received from tiles 100b and 100a, tile 100c responds to the base station 1010 with its ID and the IDs of its connected tiles 100a, 100b.

The base station 200 then iterates through each of the connected tiles 100a, 100b identified in the response 1010 with one or more adjacency queries 1015, in which the base station 200 requests information about the tiles to which each of tiles 100a, 100b is connected. On receiving the first adjacency query 1015, tile 100c queries 1015a the tile identified by the query 1015, in this case tile 100a, for information about the tiles to which tile 100a is connected. Tile 100a determines the IDs of its connected tiles and returns this information in a response 1015b. This information is returned in a response to the adjacency query 1020. The base station 200 then requests adjacency information for each of the connected tiles identified by tile 100a, and so on, until each connection and tile has been queried by the base station. From this information, the base station uses a graph constructor algorithm to construct a graph representation of the network of interconnected tiles 1030.

Returning to FIG. 9, the graph representation having been constructed, the base station 200 next acquires tile attribute data from each tile at 915. An example of this process is also illustrated in FIG. 10. The base station 200 queries 1035 the tiles in the graph for their attributes, which include state information, through one or more queries sent to the immediately connected tile 100c. Again, the base station 200 may iterate through each of the tiles, as illustrated in FIG. 10: the initial query 1035 in this example queries tile 100c for its status, which is returned by the tile 100c in a response 1040; the next tile state query 1045 is sent to the tile 100c but requests the status of tile 100a. Tile 100c accordingly forwards a query 1045a to tile 100a, to which tile 100a responds 1045b; tile 100c then provides the response 1050 to the base station 200, and so on. In this example implementation, queries and responses are handled synchronously. However, in other implementations, each tile 100a-c in the set may periodically poll its neighboring tiles for their state, and for the state of any other tiles stored in the neighboring tile's memory. In this way, the base station 100 need only poll its immediately connected tile 100c to obtain state information for the entire network of interconnected tiles 100a-c, since the state information will propagate to tile 100c.

The state information for a given tile provided to the base station 200 can include a detected force value from each of the at least one force sensors 125 of the tile. The force value included in the state information may be a value reflecting a measurement of the actual detected force, or else a binary or other quantified value (e.g., if the detected force value is greater than a defined value, a value of “on” or “1” is returned in the state information; or the returned value may be a value indicating that the detected force is in a predefined range). When a flip state of the tile is also required, the flip value (which may be a Boolean value or a flag value designating “up” or “down”) can also be included in the state information. The state information is provided to the base station 200 with other tile attribute information, such as the tile ID. Optionally, the state information is also associated with at timestamp indicating the time of the last reading; alternatively, the timestamp may be assigned by the base station 200 when the state information is received.

It will be appreciated by those skilled in the art that other messaging logic may be employed by the base station 200 and tiles 100a-c. For instance, where each tile 100a-c is equipped with a wireless transceiver, each tile can receive and respond to requests received directly from the base station 200.

Returning again to FIG. 9, once the base station 200 has acquired the state information for each tile, the data is provided to the data processing system 300 as required at 920. The initial provision of tile data by the base station to the system 300 may occur near the beginning of a current session between the base station 200 and system 300. In some implementations, the state information may be provided in a raw form to the data processing system 300, for example, where the program executing on the data processing system 300 requires a force value for a given tile.

However, the program executing on the data processing system 300 may require the state information to be processed into a different input form. This processing may be carried out by the middleware 254 executing on the base station 200. As one example, consider a game program executing on the data processing system 300 in which the user is asked to select a tile to associate with a character displayed onscreen. The selection may require the application of pressure to the tile (e.g., by the user stepping on the tile). The state information received by the base station 200 will include a detected force value and optionally a flip state; however, the game merely requires a tile ID, so the input delivered to the data processing system 300 by the base station 200 may comprise only the tile ID for the one tile in the set for which a force value above a predefined threshold was received. As another example, the input required by the data processing system 300 may also include timing information, e.g. the relative times at which two or more tiles were struck by one or more users. This information would also be provided by the base station 200 to the data processing system 300.

In response to the data provided by the base station 200, the data processing system 300 processes the data according to the rules defined by the executing program. In many cases, this results in output of a response to the data for presentation to the user at 925. This response may be in an audiovisual form (e.g., output sound and movement depicted on a display screen).

If, once the response is output 925, an end to the session is detected at 930, the operation of the system terminates. This termination may take the form of an end of game sequence implemented by the data processing system 300. The end of a session may occur due to disconnection of the base station 200 from the data processing system 300 or, where changes to the tile assembly during a session are not supported, disconnection of one or more tiles from the interconnected tile assembly. The end of a session also may be the result of a user instruction to exit the currently running program on the data processing system 300.

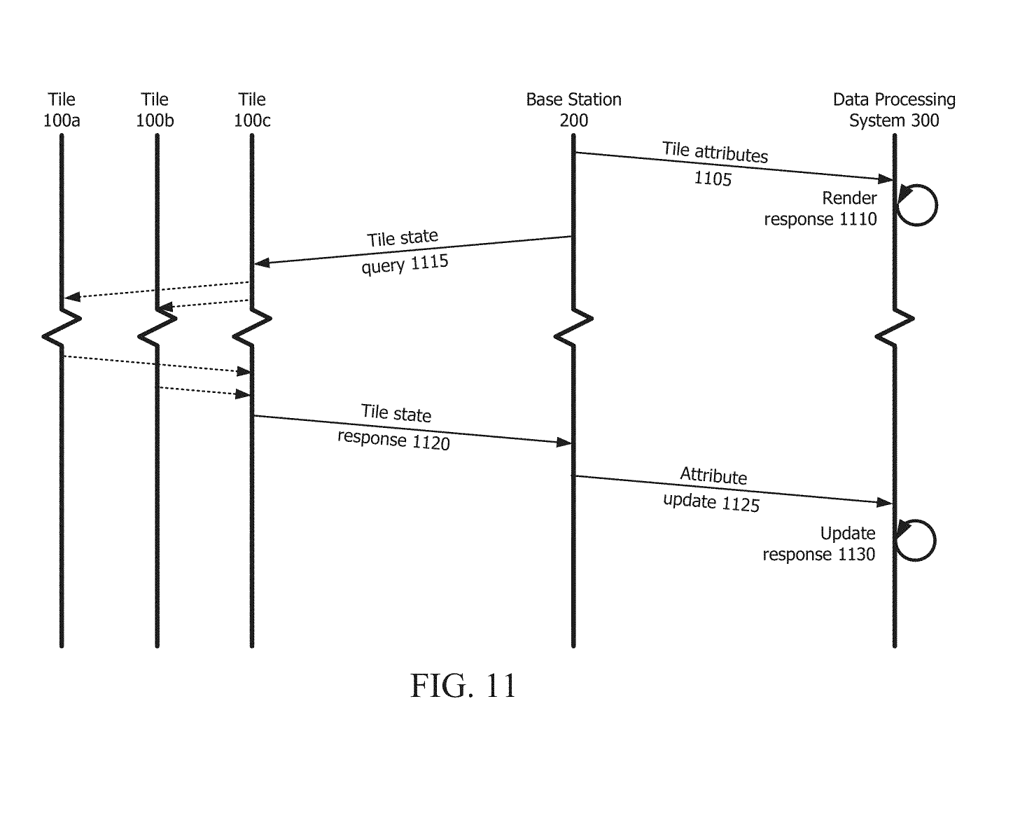

If the session continues, the base station periodically re-obtains tile data for each of the tiles in the tile assembly at 915, as described above; this updated tile data is provided in turn to the data processing system 300 at 920, which in turn outputs an updated response at 925. This process is reflected in FIG. 11: initially, the tile attributes 1105 are provided by the base station 200 to the data processing system 300, and the data processing system 300 renders a response 1110 based on the received data. The base station 200 then queries the tiles 1115 as generally described above for new state information; on receipt of a response 1120, the base station 200 processes the state data as required by the data processing system 300, then passes an update message 1120 to the data processing system 300. The data processing system 300 in turn outputs an updated response 1130.

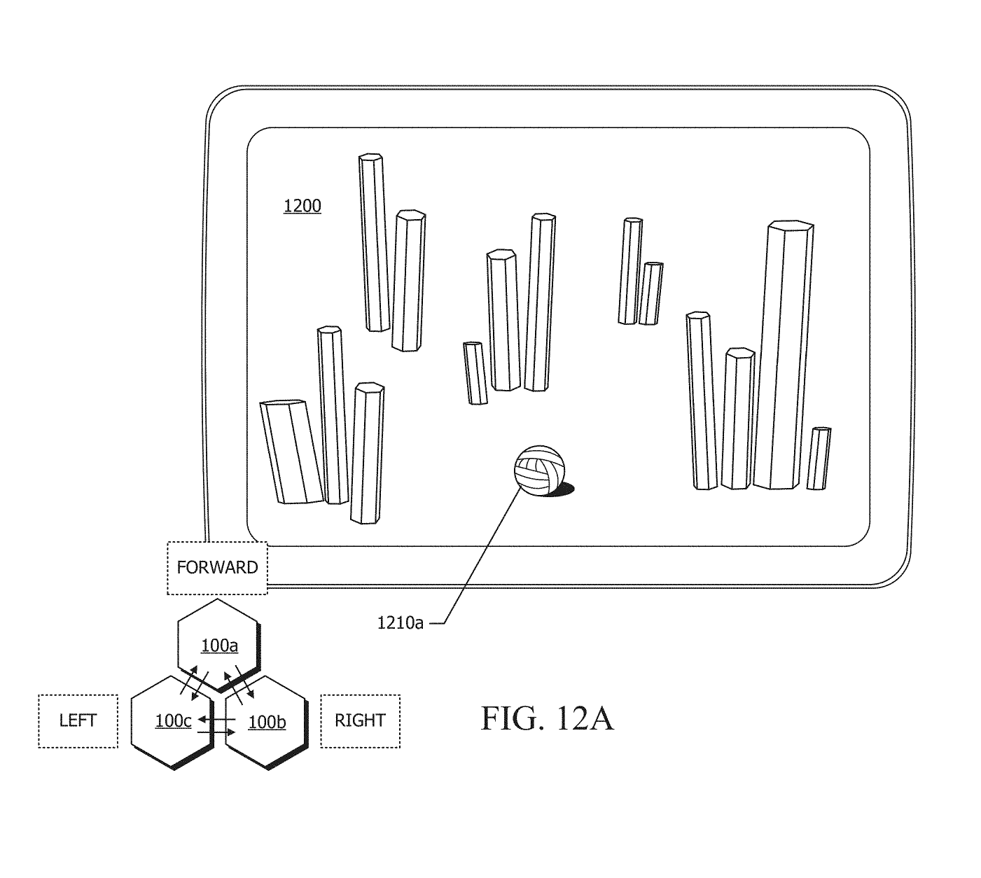

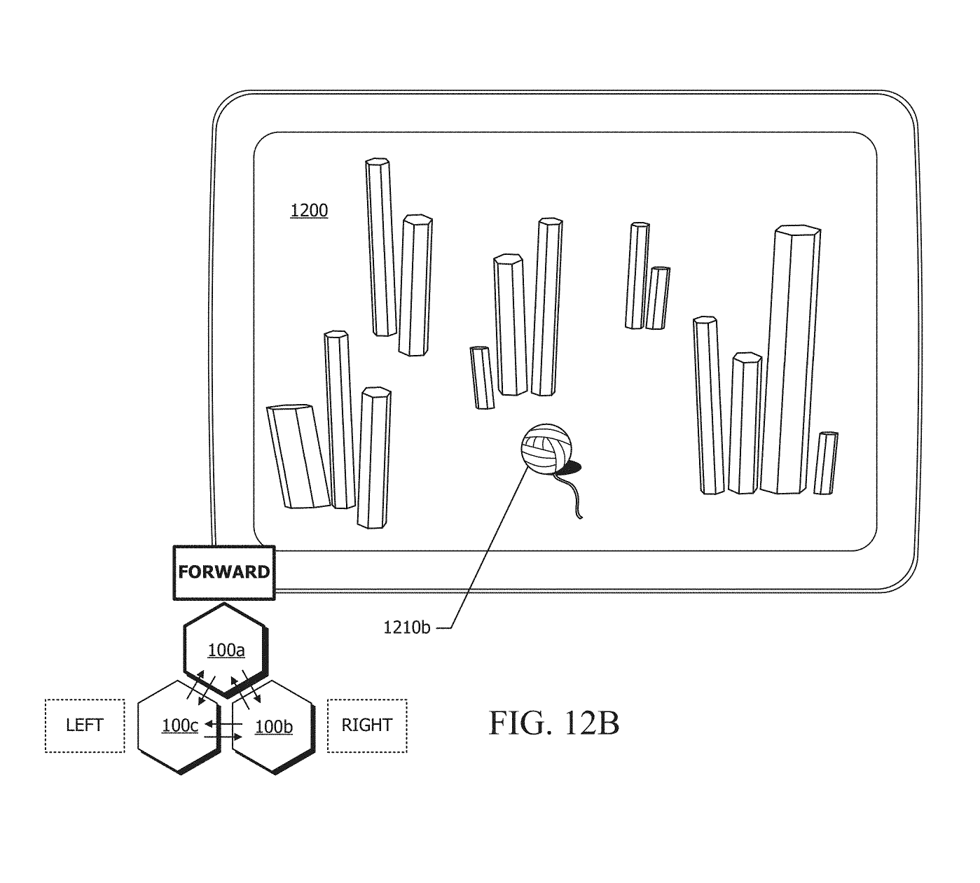

Examples of updated responses are illustrated in FIGS. 12A-12D. Turning first to FIG. 12A, an initial state of a graphical user interface 1200 of the data processing system 300 is shown. The graphical user interface 1200 includes a sprite or avatar 1210a displayed in the foreground of the scene. In this case, as mentioned above, it is presumed that tiles 100a, 100b, and 100c are interconnected as schematically illustrated in FIG. 12A. In this particular example, the tiles 100a, 100b, 100c have been associated with particular user commands (moving forward, moving to the right, and moving to the left, respectively). These associations may be determined by the program executing on the data processing system 300 based on the number and arrangement of tiles detected by the base station 200 when the graph was constructed.

Referring next to FIG. 12B, it is presumed that applied force is detected on tile 100a, associated with a moving forward action. The state information for tile 100a is therefore updated at the base station 200, which then provides updated state information for the tile 100a to the data processing system 300. In this case, since the tile 100a is associated with moving forward, the data processing system 300 responds by updating the graphical user interface 1200 by moving the avatar 1210b in a “forward” direction on the screen, as shown.

Next in FIG. 12C, applied force is detected on tile 100c, associated with a moving left action. The state information for tile 100c is then updated at the base station 200, which then provides the updated information to the data processing system 300. In turn, the data processing system responds by further updating the graphical user interface 1200 by moving the avatar 1210c in a “left” direction onscreen. Finally, in FIG. 12D, applied force is detected on tile 100b, which is associated with moving right; the state information for tile 100b is updated at the base p the graphical user interface 1200 in response by further moving the avatar 1210d to the “right” onscreen.

As mentioned above, the arrangement of interlocking tiles may be selected by the user according to the intended use; for instance, if the game program illustrated in FIGS. 12A-12D specifies an arrangement of three tiles in a substantially triangular configuration, then the user would be required to arrange tiles 100a, 100b, and 100c substantially as depicted in those figures. However, in some implementations, the operations associated with each tile may be determined based on their interconnections; for example, the game illustrated in FIGS. 12A-12D may function with three, four, or more tiles, and the tiles may be assigned alternative actions depending on their interconnections.

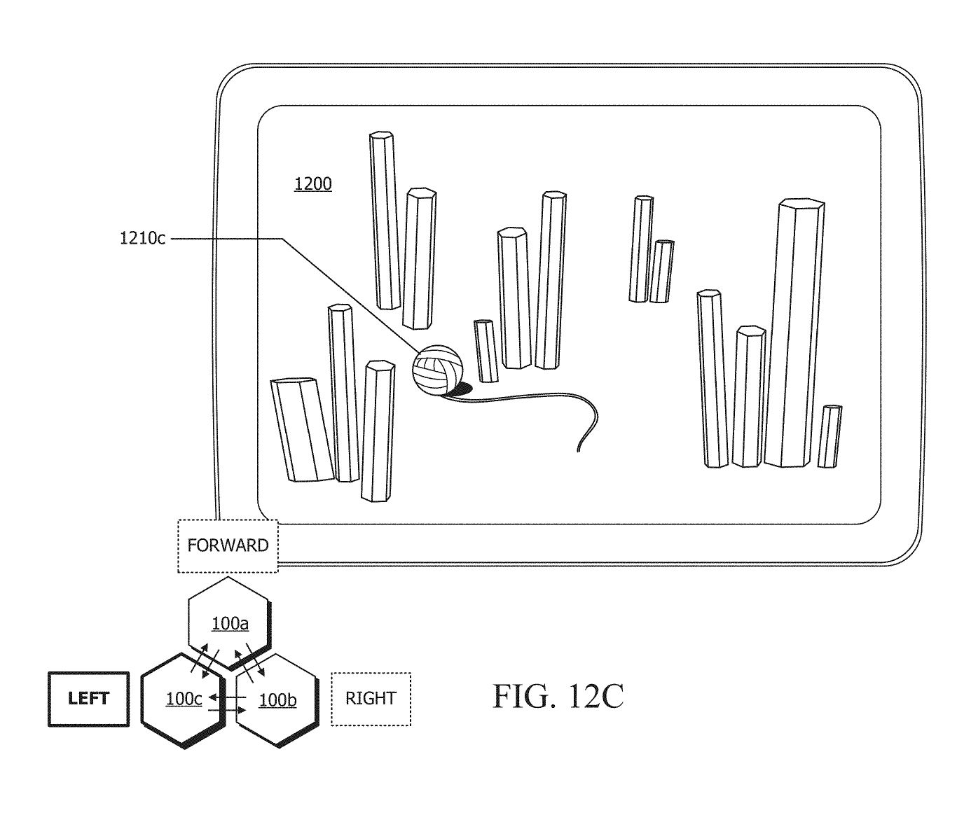

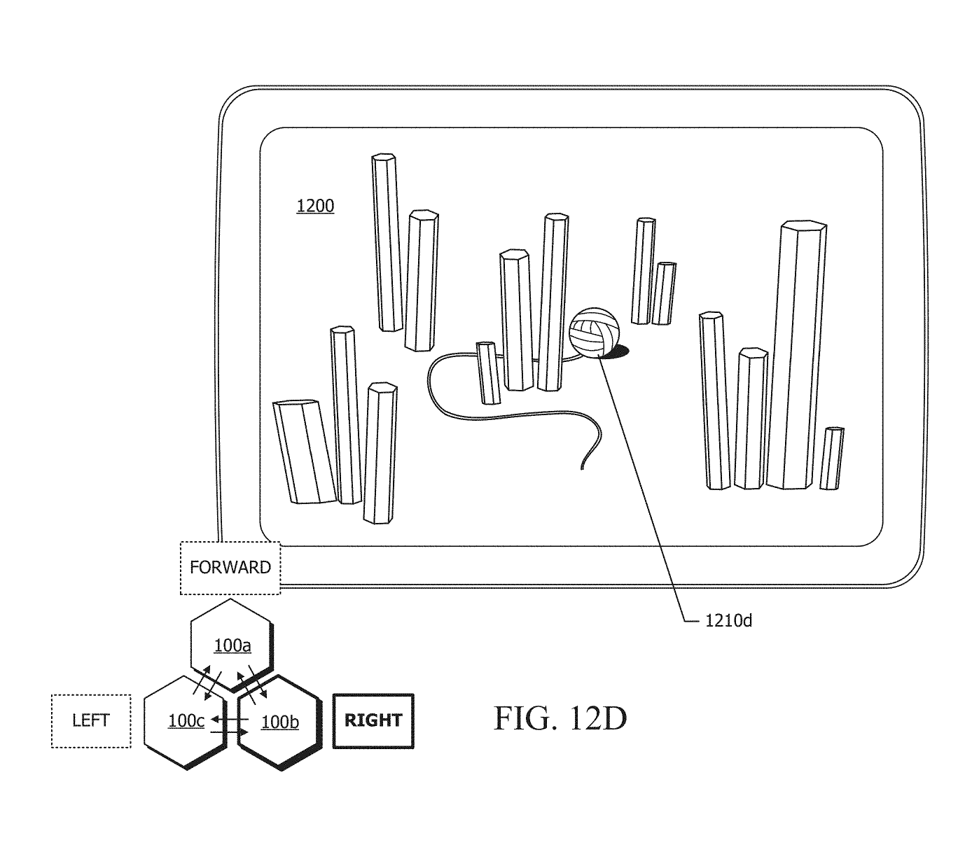

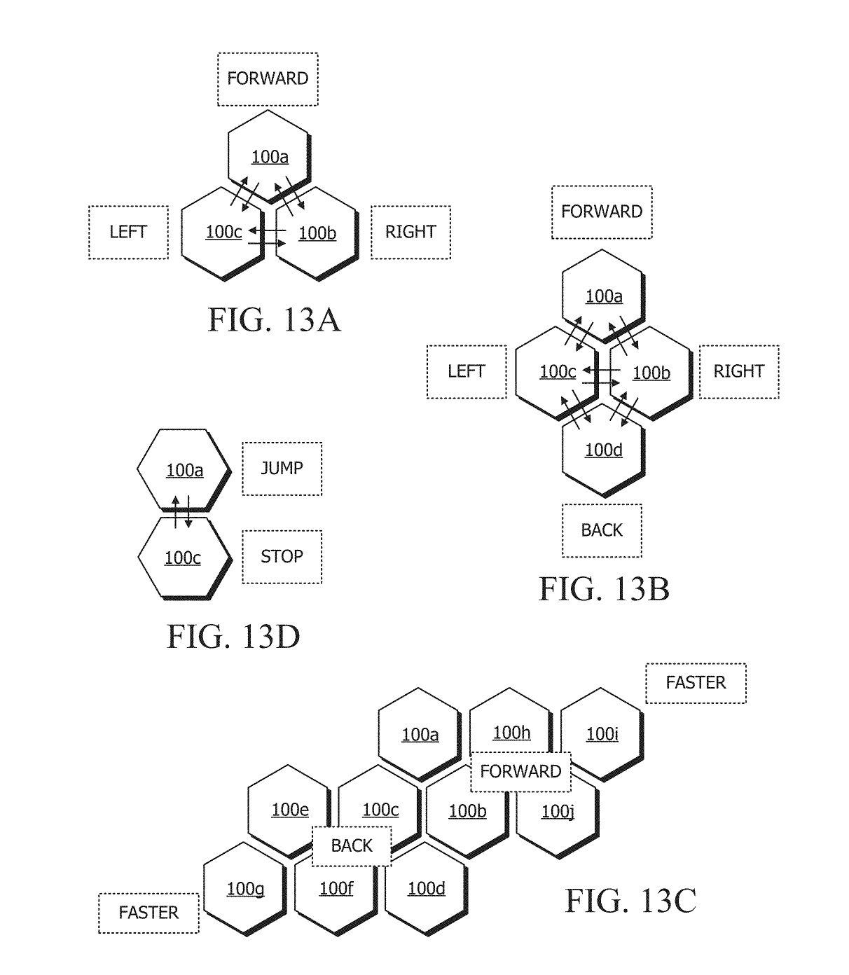

Referring to FIG. 13A, three tiles 100a, 100b, 100c are arranged as illustrated in the previous figures, with forward, left, and right actions as described above. In FIG. 13B, however, a fourth tile 100d has been added; on detection of four tiles in this configuration, the base station 200 or the data processing system 300 may assign the same three forward, left, and right actions to tiles 100a, 100c, and 100b, but assign a new “back” action to the fourth tile 100d. This “back” action was not available in the three-tile configuration of FIG. 13A, but becomes available in the configuration of FIG. 13B. (In these examples, a “stop” or “pause” command may be associated with the condition where no tile in the set has an associated force value, i.e., where the user is not applying any pressure to any tile.)

FIG. 13C illustrates still another configuration of tiles that does not associate cardinal directions to different tiles, but rather associates a scale or intensity with opposite ends of the tile assembly. In this case, it can be seen that while the original tiles 100a, 100b, 100c, and 100d remain near the centre of the assembly, additional tiles 100e, 100f, and 100g have been added to the left, and tiles 100h, 100i, and 100j added to the right, so as to define a somewhat elongated surface. In this example, the base station 200 or the data processing system 300 associates not only a direction with certain tiles or groups of tiles, but also a speed with the extremities of the surface. Thus, in this example, applied force detected around tiles 100a, 100b, 100h, and 100j may result in invocation of a move forward command in a game rendered by the system 300, but force applied to tile 100i results in faster forward movement.

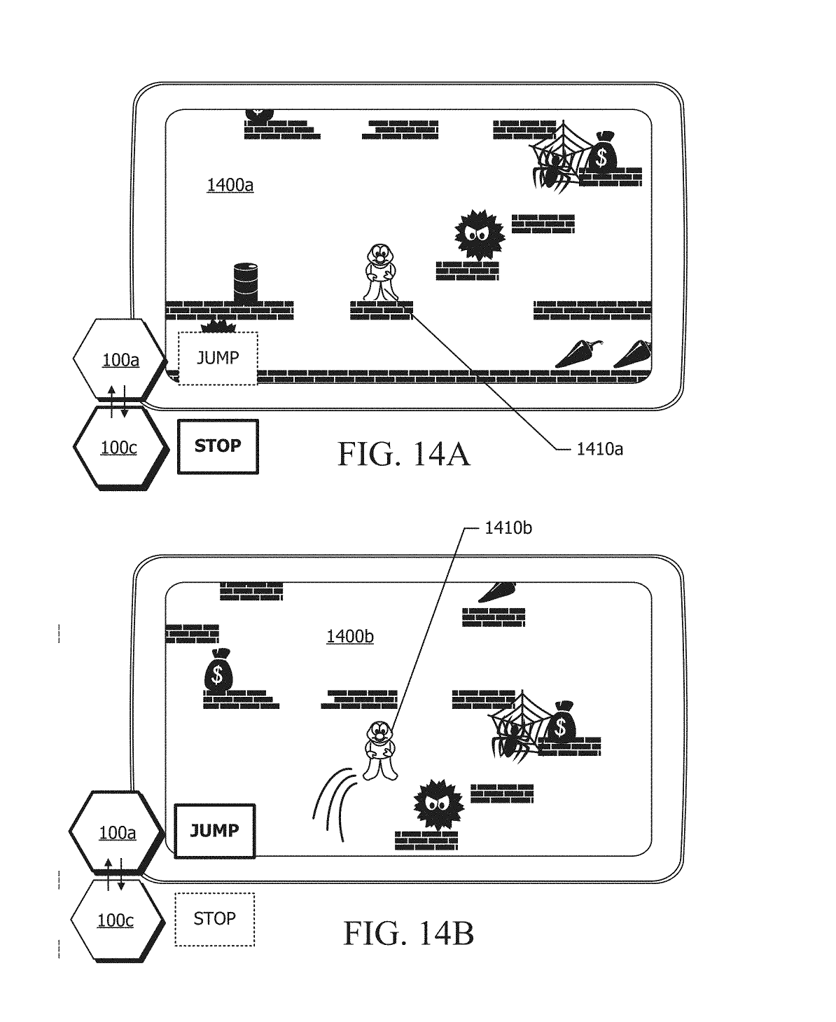

FIG. 13D illustrates that the different tiles in an assembly may be assigned to actions having different modalities. Thus, in this example, tile 100a is associated with a “jump” action, while tile 100c is associated with a “run” action. This last example is illustrated in the graphical user interfaces 1400a, 1400b depicted in FIGS. 14A and 14B, which illustrate a platform game in which a default action of the avatar 1410a, 1410b is to advance in one direction onscreen. Detection of force applied to tile 100c in this example invokes a “stop” command; the data processing system 300 therefore responds by halting motion of the avatar 1410a in FIG. 14A. Detection of force applied to tile 100a in FIG. 14B invokes a “jump” command, in which case the data processing system 300 responds by moving the avatar 1410b accordingly.

The foregoing examples depict the use of the interconnected tiles in an entertainment context. However, it will be appreciated by those skilled in the art that the interactive media system 10, and the tiles, in particular, may be used for purposes other than entertainment, such as home security or automation, by providing a reconfigurable means for detecting presence and motion due to changes in pressure on the surface of the interconnected tiles.

The data employed by the systems, devices, and methods described herein may be stored in one or more data stores. The data stores can be of many different types of storage devices and programming constructs, such as RAM, ROM, flash memory, programming data structures, programming variables, and so forth. Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by one or more processors to perform the operations described herein. The media on which the code may be provided is generally considered to be non-transitory or physical.

Computer components, software modules, engines, functions, and data structures may be connected directly or indirectly to each other in order to allow the flow of data needed for their operations. Various functional units have been expressly or implicitly described as modules, engines, or similar terminology, in order to more particularly emphasize their independent implementation and operation. Such units may be implemented in a unit of code, a subroutine unit, object (as in an object-oriented paradigm), applet, script or other form of code. Such functional units may also be implemented in hardware circuits comprising custom VLSI circuits or gate arrays; field-programmable gate arrays; programmable array logic; programmable logic devices; commercially available logic chips, transistors, and other such components. Functional units need not be physically located together, but may reside in different locations, such as over several electronic devices or memory devices, capable of being logically joined for execution. Functional units may also be implemented as combinations of software and hardware, such as a processor operating on a set of operational data or instructions.

The implementations described above are presented only by way of example and are not meant to limit the scope of the subject matter described herein. Variations of these examples and embodiments will be apparent to those in the art, and are considered to be within the scope of the subject matter described herein. For example, steps or acts and the order of such steps and acts in the processes and methods described herein may be altered, modified and/or augmented and still achieve the desired outcome. Throughout the specification, terms such as “may” and “can” are used interchangeably. Use of any particular term should not be construed as limiting the scope or requiring experimentation to implement the claimed subject matter or embodiments described herein. Any suggestion of substitutability of the data processing systems or environments for other implementation means should not be construed as an admission that the invention(s) described herein are abstract, or that the data processing systems or their components are non-essential to the invention(s) described herein. Further, while this disclosure may have articulated specific technical problems that are addressed by the invention(s), the disclosure is not intended to be limiting in this regard; the person of ordinary skill in the art will readily recognize other technical problems addressed by the invention(s).

A portion of the disclosure of this patent document contains material which is or may be subject to one or more of copyright, design, or trade dress protection, whether registered or unregistered. The rightsholder has no objection to the reproduction of any such material as portrayed herein through facsimile reproduction of this disclosure as it appears in the Patent and Trademark Office records, but otherwise reserves all rights whatsoever.

1. A tile for use in a modular interactive media system, the tile comprising:
at least one microprocessor;
at least one sensor;
a data communications subsystem in operative communication with the at least one microprocessor and the at least one sensor; and
a casing comprising:
a first face and a second face, at least one face defining a user contact surface;
a plurality of sides extending between the first face and the second face, at least one side being adapted to cooperate with at least one side of a second tile of the modular interactive media system, the at least one side comprising an interconnecting portion having:
a first pair of alignment and data connection structures, comprising a projection extending from a surface of the at least one side and a recess complementary to the projection in the surface of the least one side, a first data connector disposed in the projection and a second data connector complementary to the first data connector disposed in the recess;
a second pair of alignment and data connection structures complementary to the first pair, the second pair of alignment and data connection structures being rotated relative to the first pair of alignment and data connection structures.

2. The tile of claim 1, wherein the second pair of alignment and data connection structures is rotated 180° from the first pair of alignment and data connection structures.

3. The tile of claim 2, further comprising a first pair of magnets disposed within each projection and a complementary pair of targets disposed behind each recess.

4. The tile of claim 3, wherein the complementary pair of targets comprise ferromagnetic targets.

5. The tile of claim 3, wherein the complementary pair of targets comprise magnets.

6. The tile of claim 1, wherein the at least one sensor comprises at least one force detecting sensor.

7. The tile of claim 6, wherein the at least one sensor further comprises an accelerometer.

8. The tile of claim 6, wherein the at least one force detecting sensor comprises a force-sensitive resistor.

9. The tile of claim 1, wherein each pair of alignment and data connection structures includes a pair of complementary power connectors.

10. The tile of claim 9, wherein the complementary power connectors are included in the first data connector and the second data connector.

11. The tile of claim 1, wherein the first data connector and the second data connector comprise complementary surface mount terminal connectors.

12. The tile of claim 1, wherein each projection comprises a trapezoidal prism and each recess comprises a corresponding trapezoidal trough.

13. A modular interactive media system comprising a plurality of the tiles of claim 1.
